(19) United States
(12) Patent Application Publication
(10) Pub. No.: US 2022/0138662 A1
(43) Pub. Date: May 5, 2022

(54) METHODS AND SYSTEMS FOR ATTORNEYS RANKING BASED ON THEIR HISTORIC WORK-RELATED PERFORMANCE.

(71) Applicant: SHAKEEL MUSTAFA, LIVERMORE, CA (US)

(72) Inventor: SHAKEEL MUSTAFA, LIVERMORE, CA (US)

(21) Appl. No.: 17/515,471

(22) Filed: Oct. 31, 2021

Related U.S. Application Data
(60) Provisional application No. 63/109,880, filed on Nov. 5, 2020.

(51) Int. Cl. G06Q 10/06; G06Q 50/18; G06F 16/242; G06F 16/2457

(52) U.S. Cl. CPC G06Q 10/06398; G06Q 50/18; G06F 16/284; G06F 16/24578; G06F 16/2428

(57) ABSTRACT

Methods and systems for assessing attorney performance based on qualitative data using a software product including: collecting data about cases from at least a local, State and Federal level from databases associated with each level; collating the data into a framework comprising at least a number of cases and a type of case corresponding to one or more attorneys; ranking one or more attorneys in accordance with at least the number of cases and the type of case wherein the type of case includes: civil, administrative and criminal cases; displaying a list of the each type of case with the number of cases for a particular attorney in an order to rank the particular attorney by the type of case and the number of cases; and enabling an user upon a selection of one or more cases for a particular attorney to discover a resolution of the case whereby the user can assess the particular attorney based on a type of case, a case number and a resolution.

### CROSS-REFERENCES TO RELATED APPLICATIONS

This application claims the benefit of U.S. Provisional Application No. 63/109,880 filed on Nov. 5, 2020 at the United States Patent and Trademark Office,

### FIELD OF THE INVENTION

The present invention generally relates to ranking based systems based on historic performance of certain professionals including attorneys, and more particularly to a linking together of various data bases with court docketing data for determinations of experience, performance and result of litigation matters on the State, and Federal level before various judiciaries and administrative bodies for a particular attorney.

### BACKGROUND OF THE INVENTION

There are about 1.34 million attorneys who are members of bars of various States (and Federal courts and administrative agencies) throughout the United States of America and for that matter throughout the world who practice law at least before various State, Federal and administrative agencies. Often it is the case, that the Attorneys tend to believe or market themselves with significant experience and expertise in representing particular matters at the State and Federal courts and agencies. In fact, a quick cursory glance at the Websites of any number of solo practitioners and law firms and marketing phrases such as “We are one of the best law firms”; “We have significant legal experience”; “We win cases” are commonplace.

The general public when engaging an attorney or a law firm simply has no easy way of gauging the veracity of these claims. In other words, because of the myriad of State and Federal courts which have disjointed or disconnected docket and trial information proffered by the databases of each court, there is no easy automated may to check an attorney's experience or results in handling a particular legal matter. The public in general must rely on non-quantitative data and information from sites such as YELP® or GOOGLE® reviews when making determinations about an attorney; and that is even if such sites have review material that is available. Further, even if review material is available, it is based on subjective opinions, subject to the similar issues of veracity, and further may not even correspond to an applicable matter that is pertinent to a customer. In other words, more often than not, the user reviews are highly unreliable and based rather on legal expertise but on a handling a particular matter that may not be relevant. There is no way to determine a qualitative entire view of a range of an attorneys capabilities and to correlate those capabilities to a particular customer needs.

Therefore, it is desirable to have an easy to use graphic user interface that enables a user to search actual court records, docket reports of an attorney, to have presented a list and analysis of the results of a set of cases that have been litigated or handled by the particular attorney and to verify an attorney's claims of performance and achievement when selecting the particular which allows for an user selection of an attorney based on quantitative data and not subjective opinions.

Other desirable features and characteristics of the herein described embodiments will become apparent from the subsequent detailed description and the appended claims, taken in conjunction with the accompanying drawings and the foregoing technical field and background.

### BRIEF SUMMARY OF THE INVENTION

Accordingly, it is desirable to have a ranking system specifically designed to help general public and the attorneys to search for the best attorneys who have outstanding record and superior experience in different areas of law.

In an exemplary embodiment, a method for assessing attorney performance based on qualitative data using a software product is provided. The method includes: collecting data about cases from at least a local, State and Federal level from databases associated with each level; collating the data into a framework comprising at least a number of cases and a type of case corresponding to one or more attorneys; ranking one or more attorneys in accordance with at least the number of cases and the type of case wherein the type of case comprises: civil, administrative and criminal cases; displaying a list of the each type of case with the number of cases for a particular attorney in an order to rank the particular attorney by the type of case and the number of cases; and enabling an user upon a selection of one or more cases for a particular attorney to discover a resolution of the case whereby the user can assess the particular attorney based on a type of case, a case number and a resolution.

In another exemplary embodiment, a computer program product tangibly embodied in a computer-readable storage device and comprising instructions configurable to be executed by a processor to perform a method for ranking attorney in a locality is provided. The method includes: collecting data about cases from at least a local, State and Federal level from databases associated with each level; collating the data into a framework comprising at least a number of cases and a type of case corresponding to one or more attorneys; ranking one or more attorneys in accordance with at least the number of cases and the type of case wherein the type of case comprises: civil, administrative and criminal cases; displaying a list of the each type of case with the number of cases for a particular attorney in an order to rank the particular attorney by the type of case and the number of cases; and enabling an user upon a selection of one or more cases for a particular attorney to discover a resolution of the case whereby the user can assess the particular attorney based on a type of case, a case number and a resolution.

In yet another embodiment, a system including: at least one processor; and at least one computer-readable storage device comprising instructions configurable to be executed by the at least one processor to perform a method for configuring a display of qualitative data for assessing an attorney by use of a software product is provided. The method includes: collecting data about cases from at least a local, State and Federal level from databases associated with each level; collating the data into a framework comprising at least a number of cases and a type of case corresponding to one or more attorneys; ranking one or more attorneys in accordance with at least the number of cases and the type of case wherein the type of case comprises: civil, administrative and criminal cases; displaying a list of the each type of case with the number of cases for a particular attorney in an order to rank the particular attorney by the type of case and the number of cases; and enabling an user upon a selection of one or more cases for a particular attorney to discover a resolution of the case whereby the user can assess the particular attorney based on a type of case, a case number and a resolution.

In various exemplary embodiments, the method, further includes: displaying detailed information about the case at an appellate level; linking appellate briefs about the cases for access by the user; generating result data about the case upon a result selection by the user wherein the result data at least comprises a result of: dismissed and affirmed about the case.

The software product includes: a software-as-a-service (SaaS) application. The method, further includes: configuring a schema for each case of linking a set of attributes for connecting the databases, the attributes at least comprising: case name, case category, case updates, and parent/child couplings. The method, further includes: enabling user selection by attorney name or case type and sorting the attorneys by attorney name and case type upon user selections.

In various exemplary embodiments, a ranking method is provided that can identify the best attorneys who have filed the most number of cases across a jurisdiction including within a State. A ranking system that can identify a set of attorneys who have filed the most number of cases in a very specific area of law. For example, if a potential client is searching for an Attorney to handle client's matter in DWI (Driving While Intoxicated) Case, then obviously client would like to hire an attorney who has a proven record and demonstrable experience specifically in handling DWI Cases and not handling matters in the divorce cases. This would readily help clients to decide if the attorneys' case filing experience is recent and up to date in the specific appeal category a client would be considering them to retain.

This summary is provided to introduce a selection of concepts in a simplified form that are further described below in the detailed description.

This summary is not intended to identify key features or essential features of the claimed subject matter, nor is it intended to be used as an aid in determining the scope of the claimed subject matter.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which

FIG. 1 illustrates a typical website which contains the references of the Appeal lawyers in accordance with an exemplary embodiment;

FIG. 2 illustrates another publicly available website which belongs to the State Bar of Texas in accordance with an exemplary embodiment;

FIG. 3 illustrates the official Texas Court of Appeal Website which contains the Court related case data related to TX Appeal Court Case in accordance with an exemplary embodiment;

FIG. 4 illustrates the Case Results that are obtained by putting the bar number in accordance with an exemplary embodiment;

FIG. 5 illustrates how the display window changes when a user clicks on the weblink associated with an individual Case in accordance with an exemplary embodiment;

FIG. 6 illustrates a process where all the Case information related to the Court of Appeal Cases can be aggregated and store in a database in accordance with an exemplary embodiment;

FIG. 7 illustrates multi-tier, interconnected set of Schemas to organize the search parameters in accordance with an exemplary embodiment;

FIG. 8 illustrates the internal structure of the Schema where all the information is organized to facilitate multiple search references and criteria in accordance with an exemplary embodiment;

FIG. 9-A illustrates a proposed layout of the website design in accordance with an exemplary embodiment;

FIG. 9-B illustrates the number of Cases filed for an “N” number of attorneys being sorted from the highest to the lowest numbers in accordance with an exemplary embodiment;

FIG. 10 illustrates the complete profile of an exemplary Attorney in accordance with an exemplary embodiment;

FIG. 11 illustrates the detailed results of the Case Type “Contract” of an attorney in accordance with an exemplary embodiment;

FIG. 12 illustrates several windows, each consisting of multiple columns in accordance with an exemplary embodiment;

FIG. 13 illustrates another display scheme where the historic representation of attorneys are displayed for a particular Case in accordance with an exemplary embodiment;

FIG. 14 illustrates different options of processing the valuable information from the database in accordance with an exemplary embodiment;

FIG. 15 illustrates multiple options that a User can use to select research an appeal attorney by name in accordance with an exemplary embodiment;

FIG. 16 illustrates a typical search menu that a user can use to search appeal attorneys in accordance with an exemplary embodiment;

FIG. 17 illustrates the display which results when a user clicks on the embedded link for an attorney in accordance with an exemplary embodiment;

FIG. 18 illustrate the Table that would provide the additional information in the form of “Summary of the Cases Represented” related to an attorney in accordance with an exemplary embodiment;

FIG. 19 illustrates the names of the attorneys and their filing case status in accordance with an exemplary embodiment;

FIG. 20 illustrates that a user can click on hyperlink to display the number of cases filed by an attorney in accordance with an exemplary embodiment;

FIG. 21 illustrates the number of cases filed by an attorney for the Case Type “driving while intoxicated” in accordance with an exemplary embodiment;

FIG. 22 again illustrates the “Summary of the Cases Represented” by an attorney in accordance with an exemplary embodiment;

FIG. 23 illustrates “Selected Case Type” related to “driving while intoxicated” in accordance with an exemplary embodiment;

FIG. 24 illustrates the name of different attorney for comparison purposes for the cases this particular attorney filed in accordance with an exemplary embodiment; and

FIG. 25 illustrates a system of implement the attorney ranking system in accordance with an embodiment.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

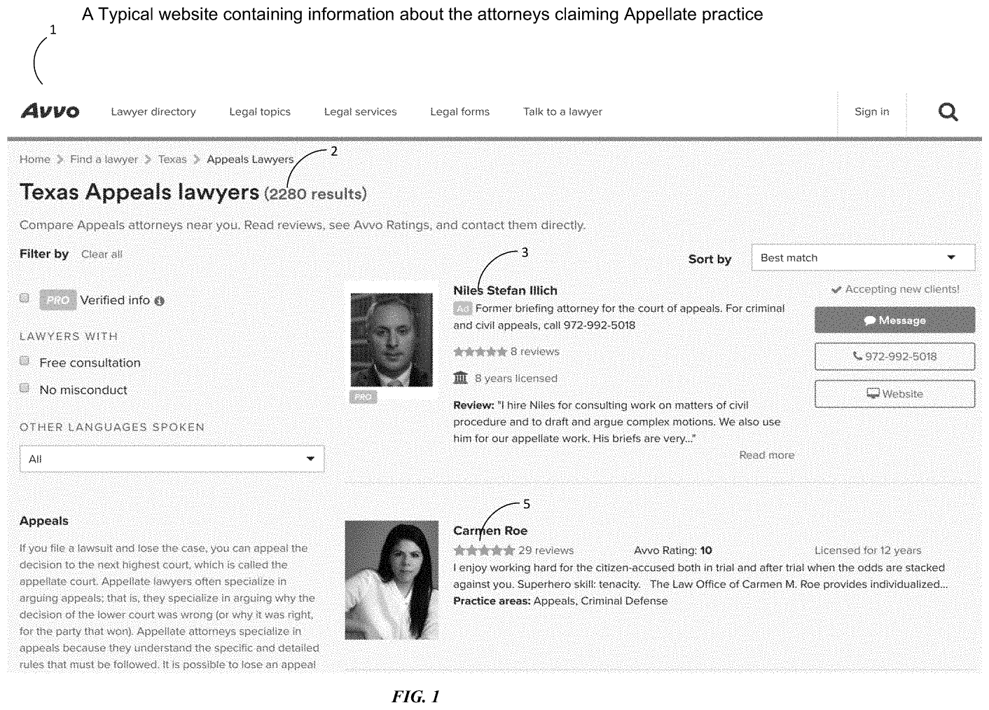

FIG. 1 illustrates a typical website that contains the references of the Appeal lawyers. The reference 1 illustrates the publicly available snapshot of the website AVVO. Nevertheless, there are other websites which tend to illustrate the attorneys who primarily practice and focus on the Appellate Law. References 3 and 5 illustrate two attorneys who appear at the top (first) page of the AVVO website when a typical user specifically is looking for the “Texas Appeals lawyers”. These two attorneys 3 and 5 along with the 2280 “Texas Appeal lawyers” 2 are referenced on said website, AVVO.

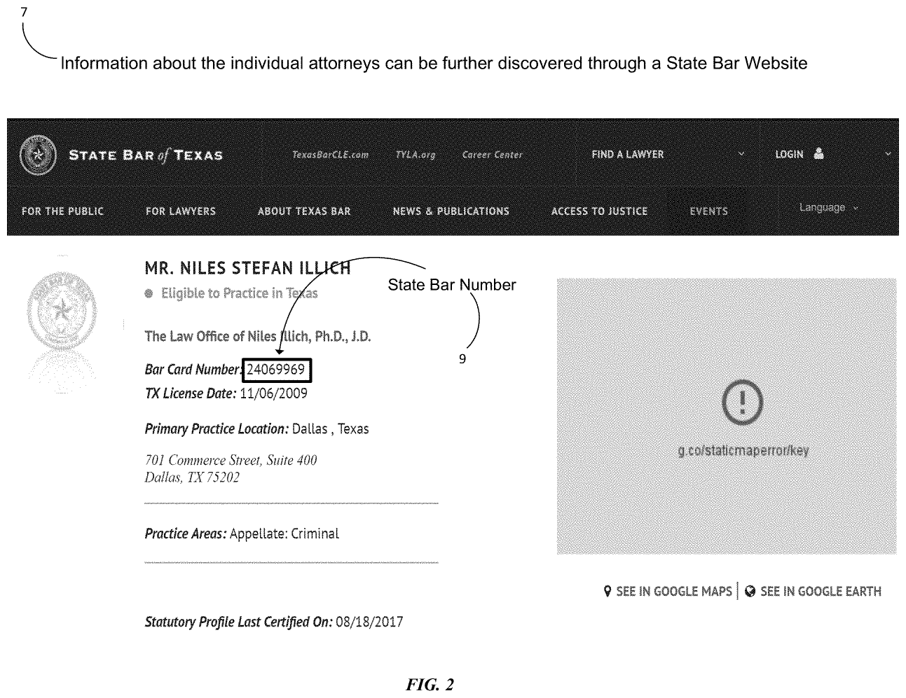

FIG. 2 illustrates another publicly available website 7 which belongs to the State Bar of Texas. The said website 7 describes in much more details about the information related to the attorney. As shown, the bar card number of the attorney 9 is shown as 24069959. The Bar Card Number is frequently used to relate the Court Cases with an attorney. The State Bar of Texas is the official website which provides information about the attorneys. Every State has a State Bar Association that displays the relevant information belonging to their attorneys.

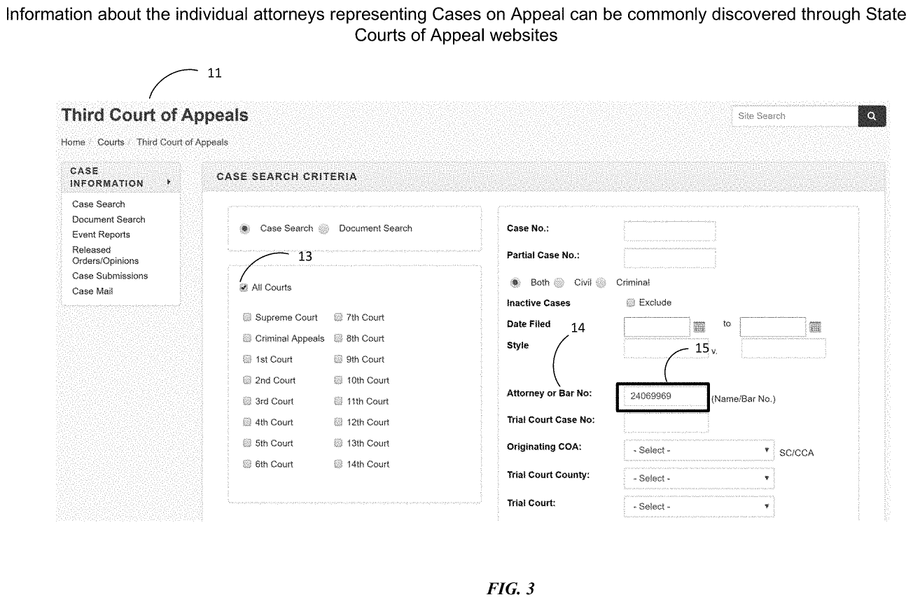

FIG. 3 shows the official Texas Court of Appeal Website 11 which contains the Court related case data related to TX Appeal Court Case Data. The website provides different search field options that can be used to search Cases. One provided option is the “Attorney or Bar No.” 14. Since different attorneys could have the same names, it is advisable to use their Bar number 14 for the Case search purposes as it uniquely identifies each attorney in the State of Texas.

Furthermore, the Court Website provides a checkmark option 13 which can enable the Case Search across all of the Courts of Appeal Website, ranging from TX Supreme Court, 1st Court of Appeal to 14th Court of Appeal.

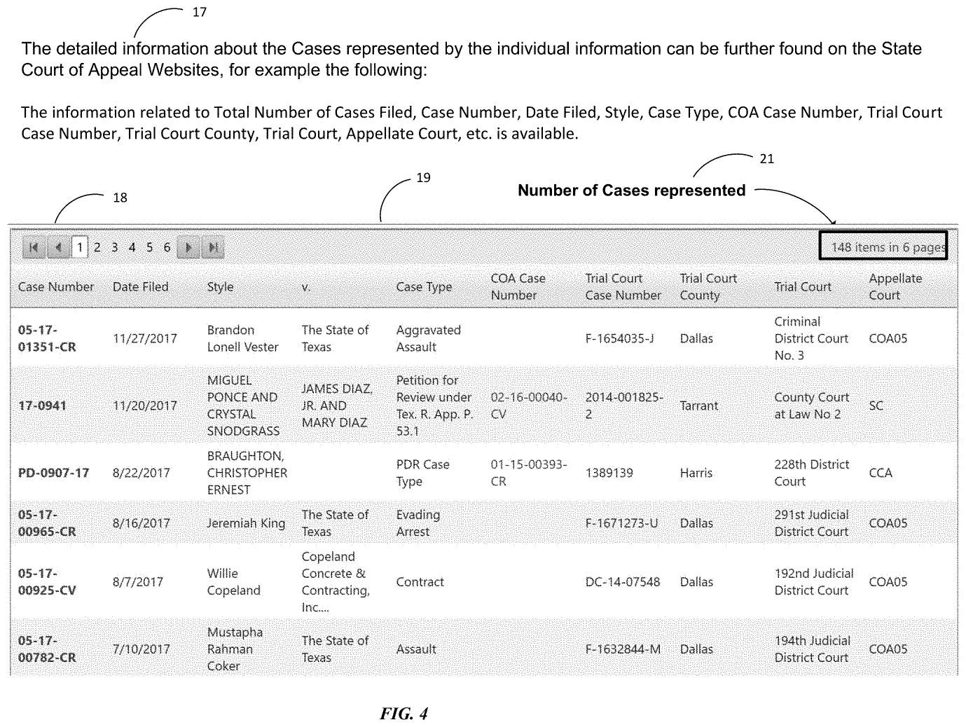

FIG. 4 shows the Case Results 17 that are obtained by putting the bar number 24069969, belonging to an Appeal attorney, Niles Stefan Illich as shown 3 in FIG. 1. The yielded search 21 shows 148 Case Results belonging to the attorney, Niles Stefan Illich through his unique Texas Bar assigned number 24069969. The tab 18 can be clicked to advance to the next page showing additional Case Results for the said attorney. The display window 19 can be adjusted in size to facilitate the displayed case results.

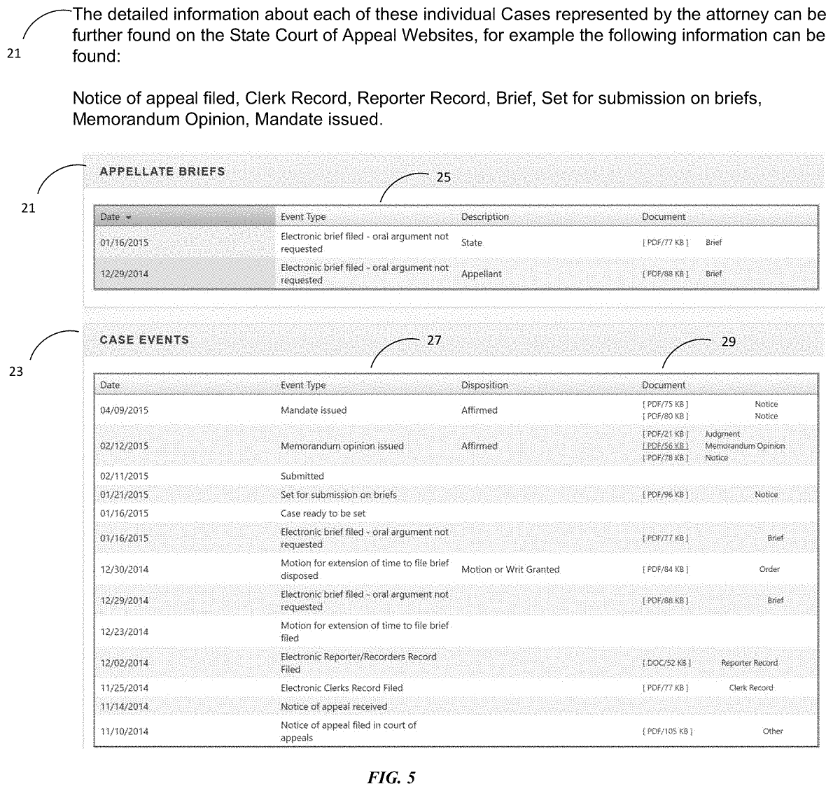

FIG. 5 shows that when a user clicks on the weblink associated with an individual Case, the website opens a new tab or window where the details belonging to the Case Events 23. The Case Events Bar 27 further shows the Date when the Case was filed, the event type, disposition, and the documents associated with the Case 29. Furthermore, FIG. 5 shows a small display window 21, APPELLATE BRIEF, which shows Event Type 25 reporting the status of the Appellant and Appellee briefs. Further, the documents associated with the briefs are also shown.

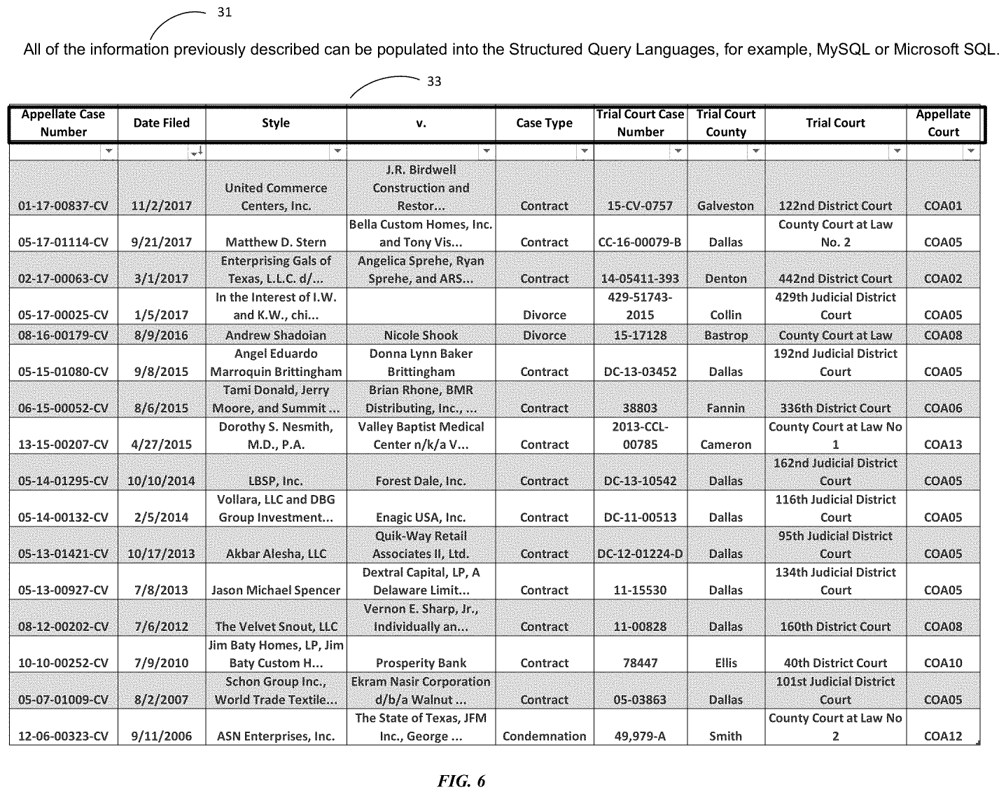

FIG. 6 shows a process 31 where all the Case information related to the Court of Appeal Cases can be aggregated and store in a database 33. The database 33 can also include customized fields that can further enhance the processing and meaning of information in the database. As suggested 31, the information can be processed through standard Structured Query Language, for example, MySQL and Microsoft SQL. Furthermore, Artificial Algorithms can be used to further refine the search results.

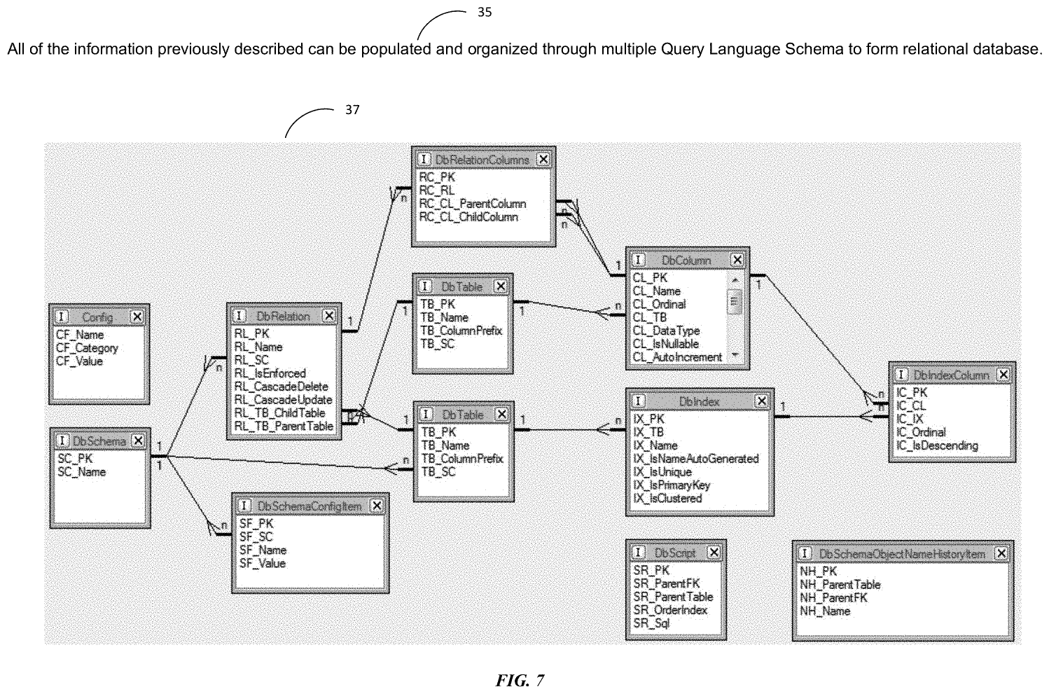

FIG. 7 shows multi-tier, 37 interconnected set of Schemas to organize the search parameters. With the said Schemas, multiple queries can be organized and generated to search, organize and arrange different parameters. As shown 35, the information in the database can be saved in to different Schemas.

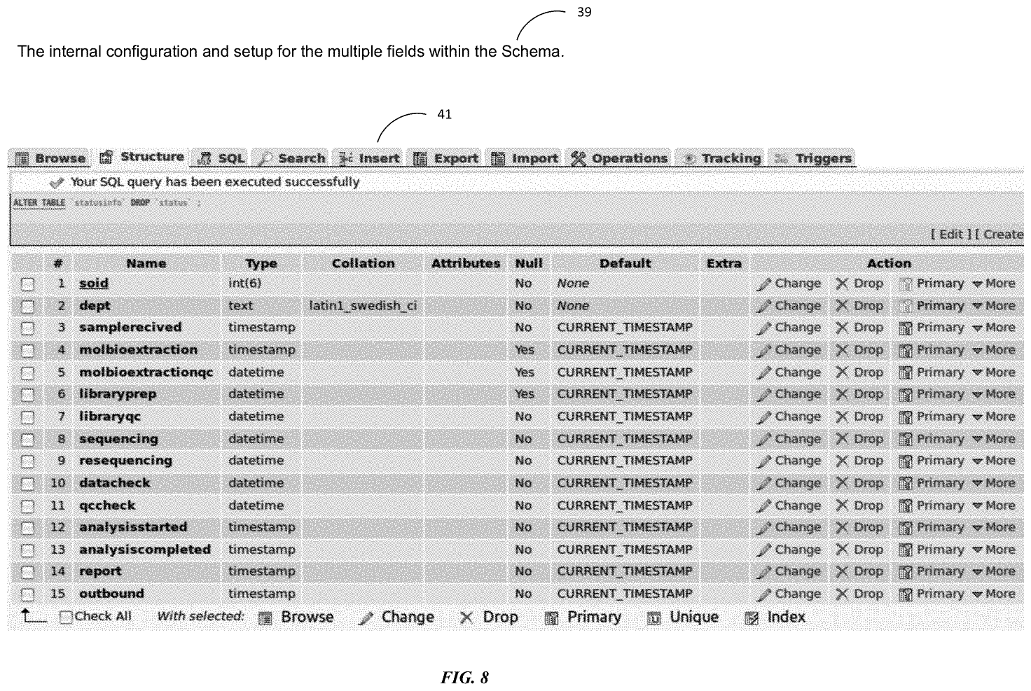

FIG. 8 shows the internal structure 39 of the Schema where all the information is organized to facilitate multiple search references and criteria. As shown 41, there could be multiple fields organized and arranged through different set of information.

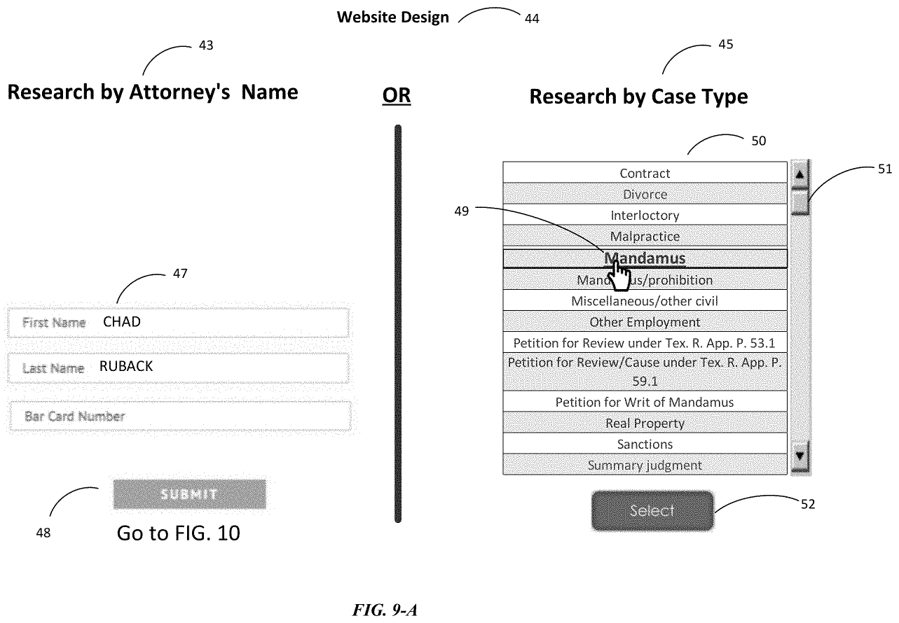

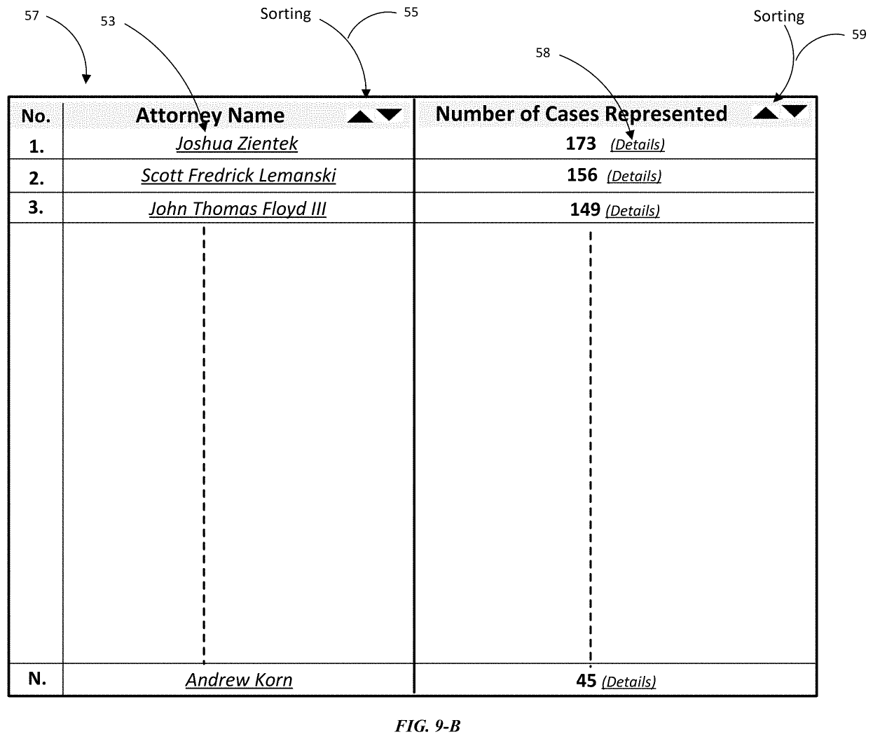

FIG. 9-A shows a proposed layout of the website design 44. The website is conveniently divided into two sections.

Research by Attorney's Name 43 or Research by Case Type 45. In the “Research by Attorney's Name” 43, a user can enter the First Name, Last Name or Bar Card Number, in 47. As an example, the User has entered the attorney name as Chad Ruback.

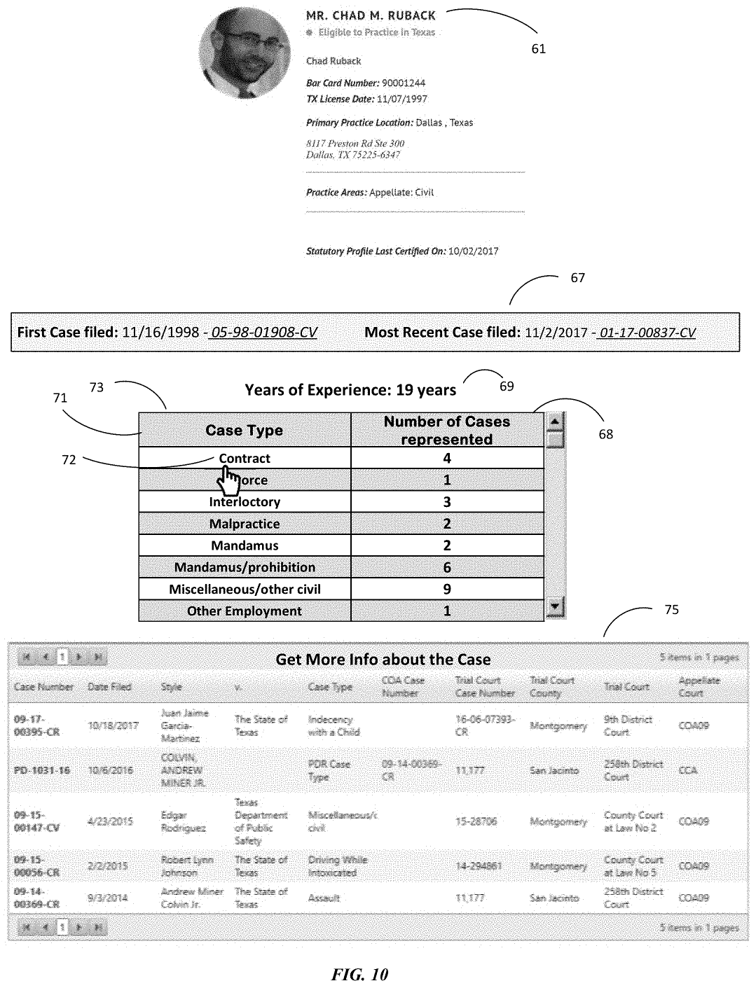

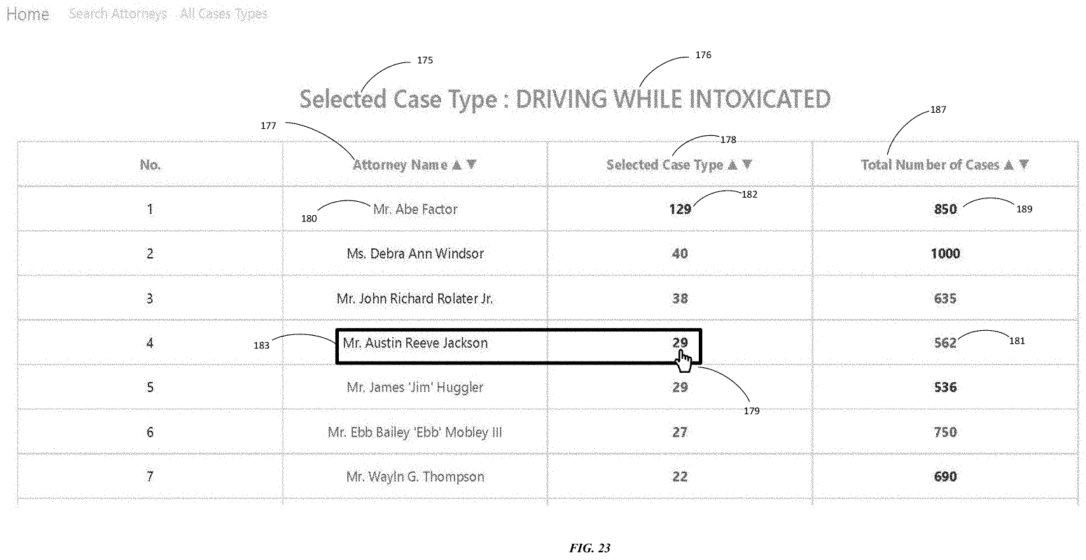

As shown in FIG. 9-A, when a user clicks on the “Submit” button, 48, the webpage is directed to a new webpage shown on FIG. 10. Furthermore, a user can opt to research an attorney based on the “Research by Case Type” option 45. All types of Case classifications are populated in a Tabular format 50. The Tabular format also has scroll bar that can be used to scroll down through the Table 51. The entries in the Table represents virtually ALL Case Types preferably in the Tabular Format 50. As an example, a user selects the row referring to “Driving while Intoxicated” entry 49. Once clicked through the “Select” button 52, the webpage is updated with the entries as shown on FIG. 23.

FIG. 9-B shows the number of Cases filed for an “N” number of attorneys being sorted 59 from the highest to the lowest numbers. The corresponding names of the Attorneys are displayed in 53. The Attorneys names can be sorted through 55. A user can click on the hyperlink containing the Attorney's name 53 or alternatively the hyperlink embedded with the word “Details” 58. Similarly, a user can click on the “sorting” button 55, which can sort the results by the individual names of the attorneys.

By default, the website is designed to display the list of attorneys who have filed the most number of Cases 57 throughout ALL of the Texas Courts of Appeal together. Referring back to FIG. 9-A, when a user clicks on the “submit” button 48, the webpage opens up its contents on FIG. 10.

As shown in FIG. 10, the complete profile of the exemplary Attorney Chad Ruback 61 is shown, it would contain the most recent contact info of the said attorney 61, primarily driven from the State Bar Website. A small horizontal Window 67 shows the information reference to the First Case number and the date filed with any Court of Appeal by the said attorney 61 and then the latest Case number with the date filed. The next reference 69 shows the number of years of experience that the said attorney has. The tabular form 73 provides the summary for ALL the Case Types represented by the said attorney 61. The Table has two columns, Column 71 represents the Case Type whereas Column 68 represents the Number of Cases represented by the said attorney during the course of his appellate practice, i.e. Texas Courts of Appeal.

By default, the Case Types are represented in the alphabetic ascending order. Against each Case Type, the total number of Cases handled by the said attorney are indicated. A user has the choice to click on any of the Case Type to see the detailed performance of the said attorney in handling the selected Case Category. As an example, when the user clicks on “Contract”, 72, all of the Cases that the said attorney 61 handled under the “Contract” Case Types are displayed in the Table 75.

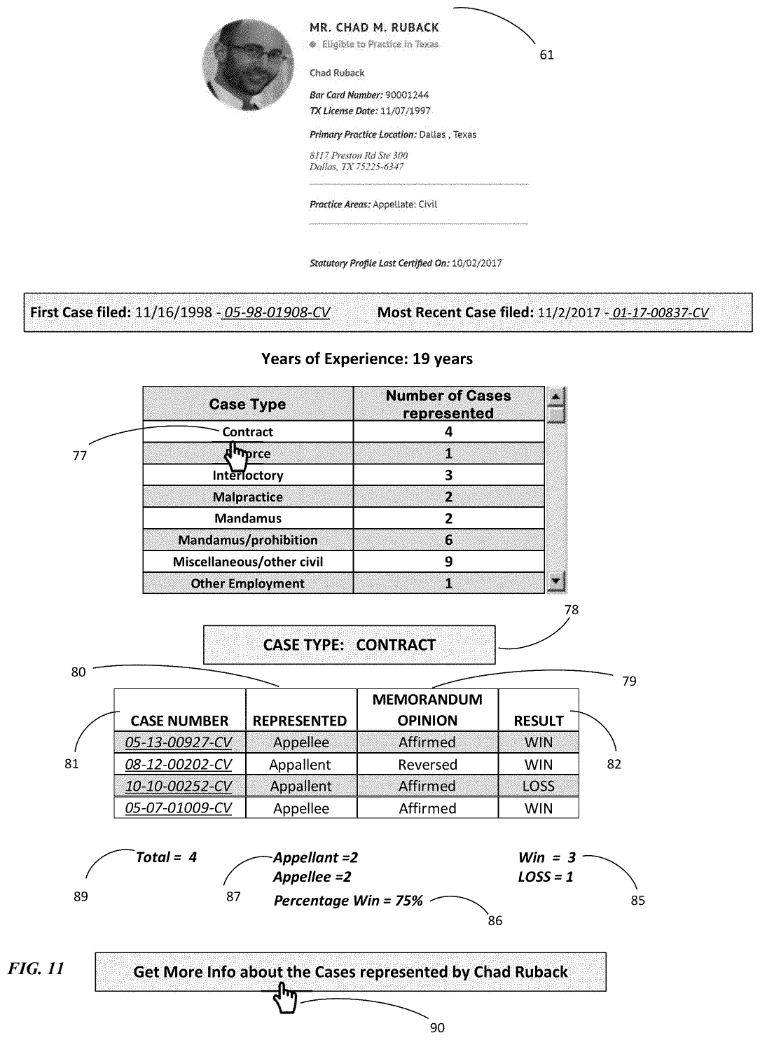

FIG. 11 shows the detailed results of the Case Type “Contract” that the said attorney, Mr. Chad Ruback 61 took under his representation. The small window 81 identifies the Case Type 77, “Contract” that as an example, the user can chose by clicking on it. The result of clicking on the Case Type “Contract” are displayed through a window containing multiple columns. The Column 81 contains the list of all the Case Numbers in which the said attorney “Chad Ruback” has represented the Cases involving “Contract”. If the user clicks on the weblink associated with a Contract Case, then he can access the details of the clicked Case. Column 80, containing the heading “Represented” shows the said attorney either represented Appellee or Appellant in the Case. The Column 79, “Memorandum Opinion” shows whether the particular Case outcome was either Affirmed or Reversed. The Column 82 with the heading “RESULT” classifies in a very loose term that whether the outcome was a “WIN” or a″LOSS″. As an example, if the said attorney has represented an Appellant and he receives a reversal of the Case, then that can be reasonable considered as a WIN.

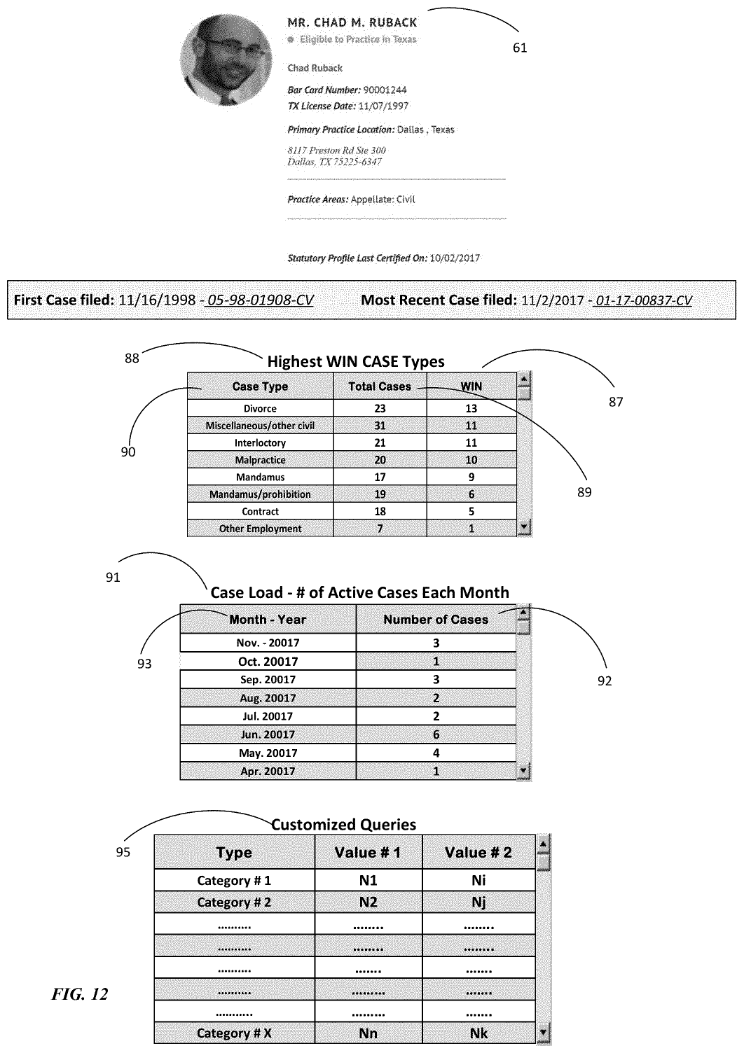

The Webpage content further shows the total Cases 89 represented by the said attorney, the number of cases in which the said attorney either represented Appellant or the Appellee 87, the number of Cases that the said attorney loss or won 85 along with the percentage of the success is also shown as referenced by 86. If the user further clicks on the small window 90, then the program will take the user to the next webpage that will show a different set of info related to the said attorney as shown on FIG. 12.

FIG. 12 shows several windows, each consisting of multiple columns. As an example, the window with the title “Highest WIN Case Types” 88 has three columns. The Column 90 with the title “Case Type” show all of the Case Types represented by the attorney Chad Ruback 61. The next Column with the title “Total Cases” 89 shows the total number of Cases represented by the said attorney in each of the Case Types. The Column with the title “WIN” 87 represents a relative interpretation of number of times that the said attorney succeeded in the objective of his representation. For example, in the “Divorce” Case Type, the said attorney succeeded in the objective desired by either Appellant or by Appellee 13 times out of 23 Cases filed for the Divorce.

Similarly, another Window by the heading “Case Load-# of Active Cases Each Month” 91 consisted of two Columns. The Column 93 with the Title “month-year” reports the total number of Cases that have any type of activity during that month. The Column 92 reports the actual number of active Cases for the said attorney in that particular month-year. The user can scroll down to view the Cases for the other month-year time period.

The present invention also supports the layout and display of the customized queries across different fields in the database. As an example, the heading “Customized Queries” 95 can be consisted of multiple Columns, for example, users' defined Type Column, Column Value #1, to Column Value #2 and so on. In the Type Column, a user can populate different categories, ranging from Category #1 to Category # X, whereas the Column Value #1, can contain different values from N1, N2, . . . Nn, Similarly, Column Value #2 can contain values ranging from Ni to Nk. The columns fields can be related and searchable through structured query languages like MySQL or Microsoft SQL.

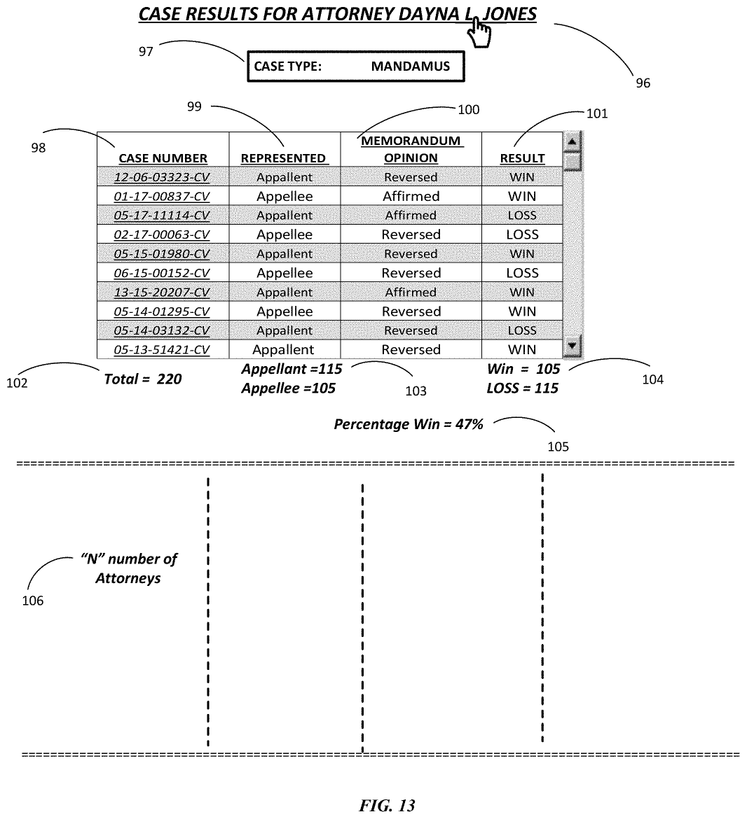

FIG. 13 shows another display scheme where the historic representation of the attorneys for a particular Case Type can be displayed. As shown the Case Type with the heading “Mandamus” 97 have been undertaken by several different attorneys. The Case Results for “Attorney Dayna L. Jones” 96, as an example, specifically for the Case Type “Mandamus” 97. The Column 98 represents the “Case Number” undertaken by the said attorney 96. The Column 99 with the title “REPRESENTED” indicates whether the said attorney represented the Appellant or Appellee in the specific Case. The Column 100 with the title “MEMORANDUM OPINION” indicates whether the said Case was Reversed or Affirmed. The Column 101 with the title “RESULT” represents status that the said attorney 96 succeeded in his/her Case objectives. The field “Total” 102 represents the total number of Cases for the Case Type “MANDAMUS” 97 that the said attorney undertook his/her representation. The number Appellants or Appellees represented by the said attorney for the Case Type “MANDAMUS” are also reported 103. The number of “WIN” or “LOSS” 104 are also reported for the specific Case Type “MANDAMUS” 97. The “Percentage Win” 105 is also reported for the said attorney for handling the Case Type “MANDAMUS” 97. The above window format continues to include the same reporting layout for the other attorneys who represented their Clients specifically for the “MANDAMUS” Case Type 97. This is shown by “N number of Attorneys” 106.

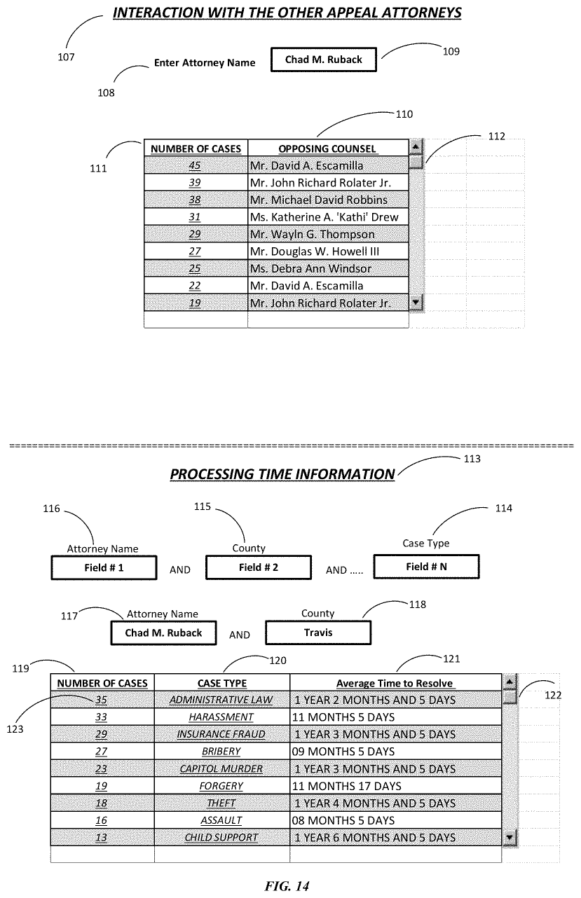

FIG. 14 shows different options of processing the valuable information from the database. One searchable option “INTERACTION WITH THE OTHER APPEAL ATTORNEYS” 107. A user can enter the name of the attorney in the dialogue box 108. As an example, the attorney name “Chad M. Ruback” 109 is entered. The Table with two columns shows the results. The first Column 111 labeled as “NUMBER OF CASES” display the number of Cases that the said attorney, for example, “Chad M. Ruback” 109 engaged with the opposing counsels. The Column labeled as “OPPOSING COUNSEL” 110 display the names of the attorneys who represented the parties against the said attorney “Chad M. Ruback” 109. The user has an option 112 to scroll down through the list of attorneys.

FIG. 14 shows another option 113 which can provide the “PROCESSING TIME INFORMATION”. The FIELD #1 referenced as 116 can accept the input of the “Attorney Name”. The FIELD #2 referenced as 115 can accept the input for the County and an Nth FIELD # N referenced by 114 can accept the Case Type as an input from the User.

Furthermore, as an example, the user enters the attorney name “Chad M. Ruback” 117 and then enters the County Name 118 as “Travis” County. The results are shown in the following Table. The Column labeled as “NUMBER OF CASES” 119, represents the number of cases. The Column 120 represents the “CASE TYPES”, the Column 121 labeled as “Average Time to Resolve”. As an example, the said Table shows that the said attorney “Chad M. Ruback” 117 resolved 35 Cases pertaining to the Case Type “Administrative Law” with the Average time to Resolve for 35 Cases was “1 YEAR 2 MONTHS AND 5 DAYS”

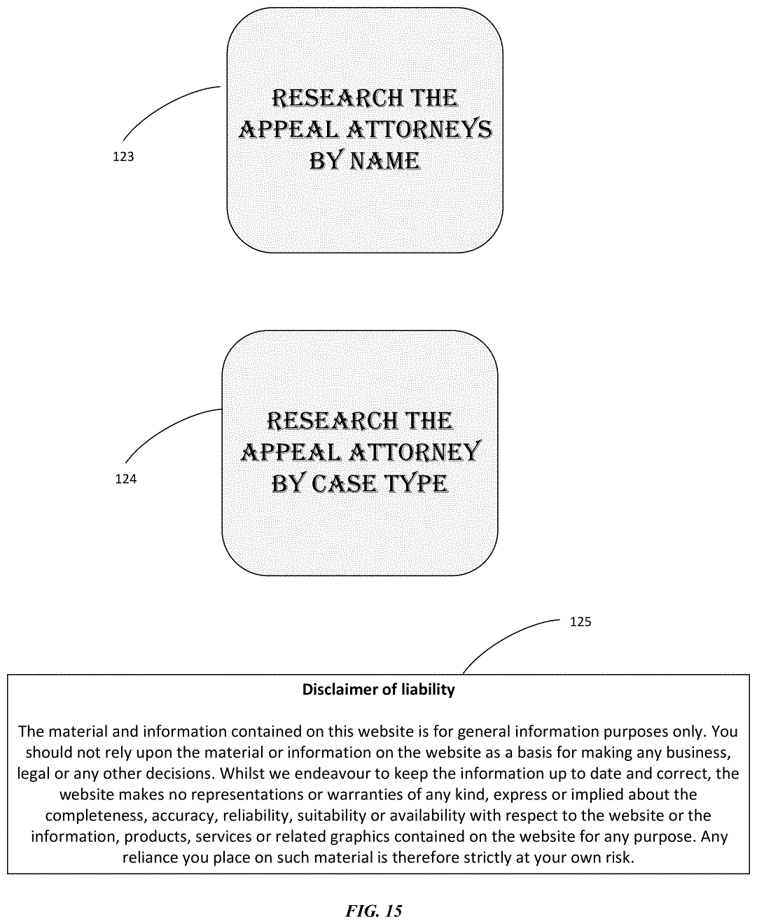

FIG. 15 shows two options that a User can use to select either “Research the Appeal Attorney by Name” 123 or the option to “Research the Appeal Attorney by Case Type” 124. FIG. 15 further shows the appropriate Disclaimer Notice 125 that needs to be displayed to avoid any legal liability for the use of the said websites' functions, features and the services a user may intend to utilize.

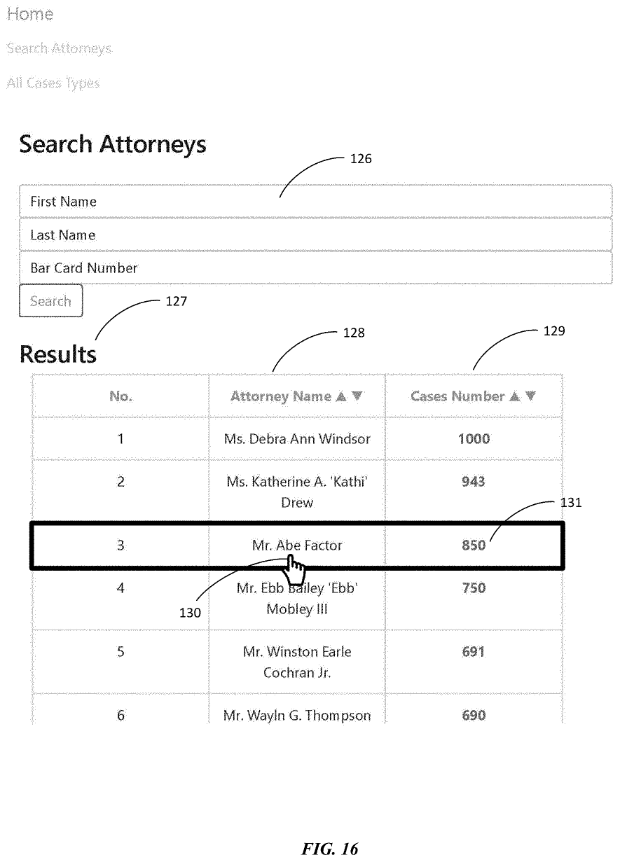

FIG. 16 shows a typical search menu that a user can use to Search Appeal Attorneys. The simple menu 126 needs an input in the form of “First Name”, Last Name” or Bar Card Number. Any of the above input feed will find the Appeal Attorneys matching the user's input criteria. By default, when the user has not entered any search criteria, the “Results” 127 will display the list of the names of the Appeal Attorneys who have filed the most number of Cases in the descending order. It will display the name of the Attorney in Column 128 and the Total Number of Cases 129 filed by the Attorneys. For example, the user can click on the name of the attorney, “Mr. Abe Factor” 130 who has filed 850 number of Total Cases, referenced by 131, with the TX Court of Appeals.

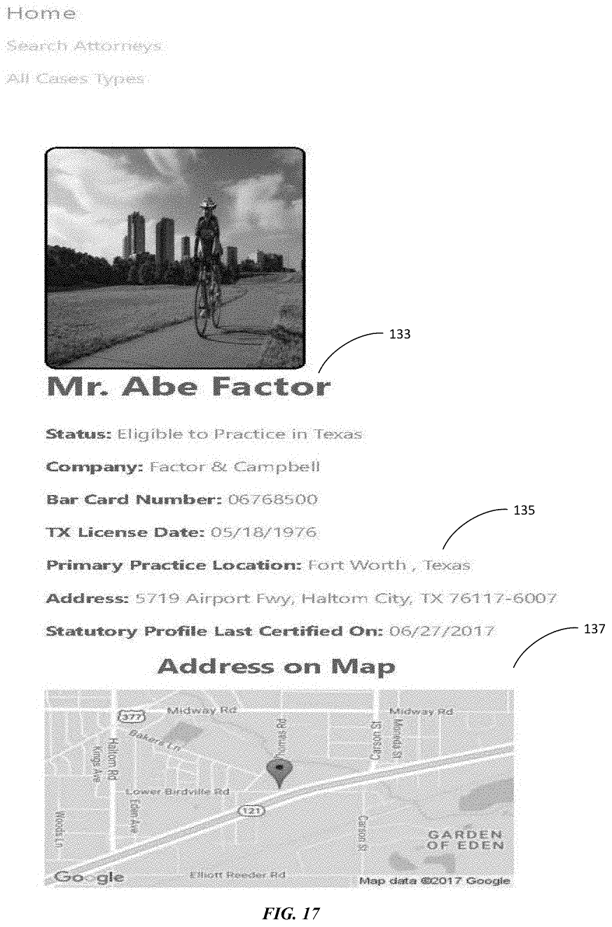

FIG. 17 shows that when the user clicks on the embedded link for the attorney, Mr. Abe Factor” 130 shown on previous FIG. 16, it would display the contact information 133, with additional information 135 and also a map 137 that shows the geographical office location of the said attorney.

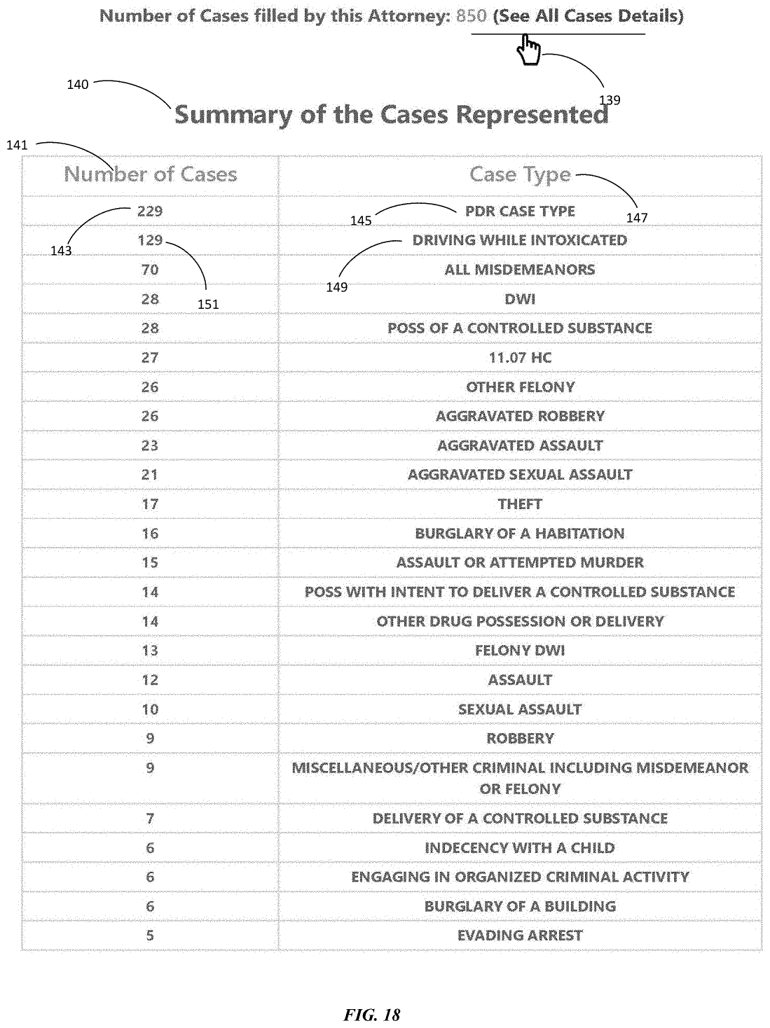

FIG. 18 show the Table that would provide the additional information in the form of “Summary of the Cases Represented 140, related to the attorney, “Mr. Abe Factor” 129. The said Table provides this information into two Columns, Column 141 provides the most “Number of Cases” filed by the said attorney in a specific Case Type 147. Whereas the Column 147 indicates different “Case Types”. For example, the said attorney “Mr. Abe Factor” 129 has filed 229 Cases as referenced by 143 in the “PDR Case Type” referenced by 145.

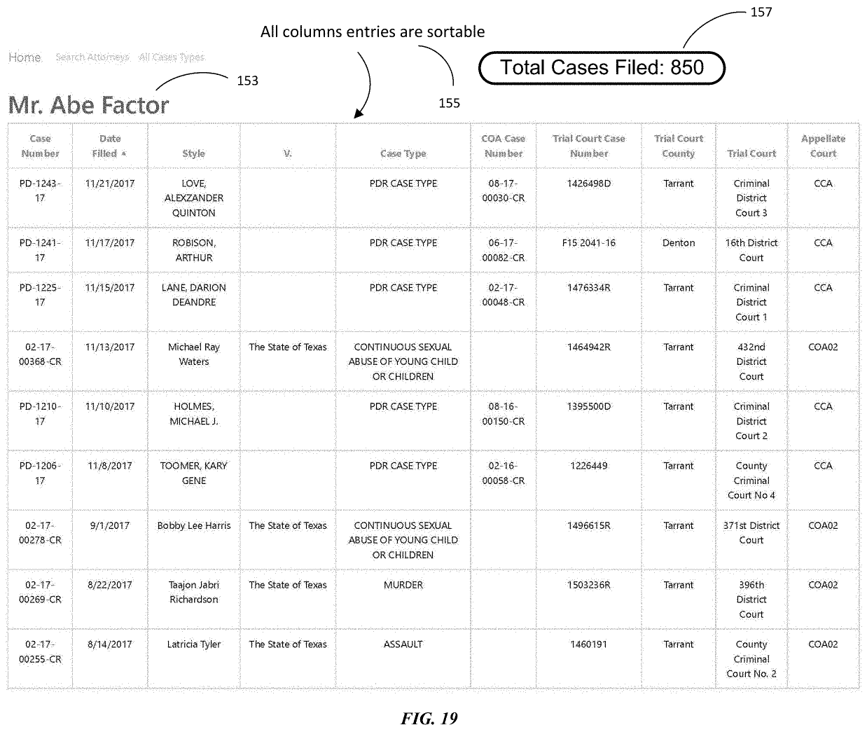

Similarly, the FIG. 18 shows that the said attorney “Mr. Abe Factor” has filed 129 Cases referenced by 151 in the Case Type of “DRIVING WHILE INTOXICATED” referenced by 149. A User may choose to click through his mouse cursor 139 on the hyperlink of “See All Cases Details”. When the User clicks on the said hyperlink, the Program will open up another webpage as shown in FIG. 19.

The said FIG. 19 shows the name of the attorney, in this case “Mr. Abe Factor” 153. The Total Cases Filed by the said attorney that would be 850 as referenced by 157. In addition, all of the said columns with their displayed set of information are sortable 155, either through descending or ascending order.

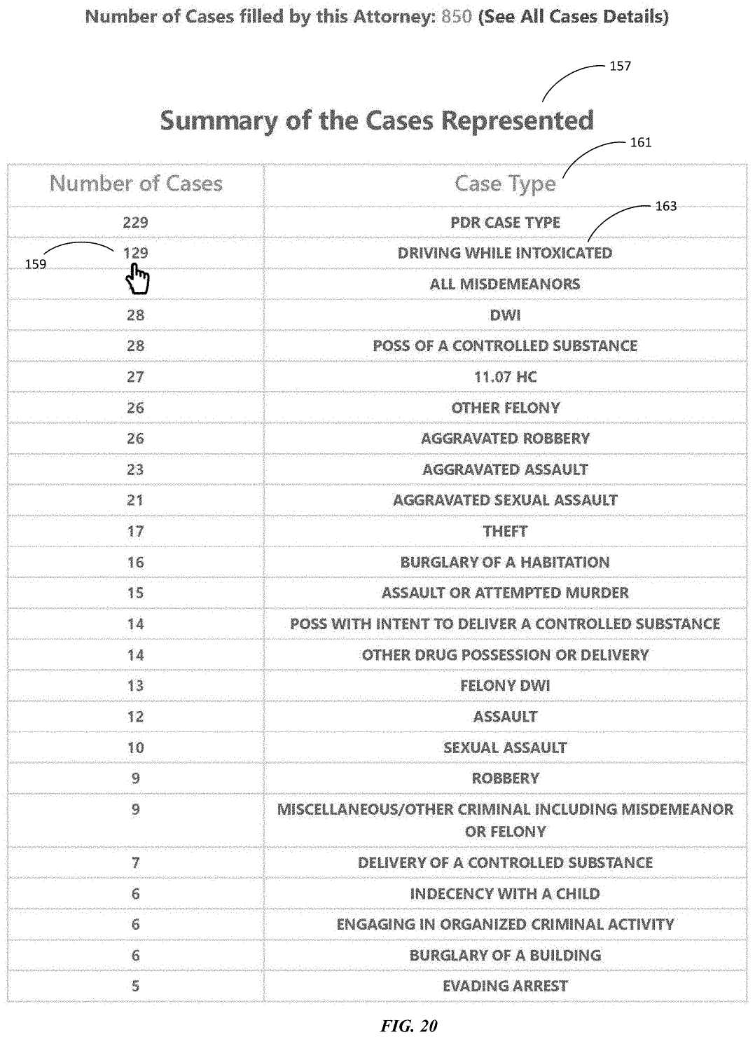

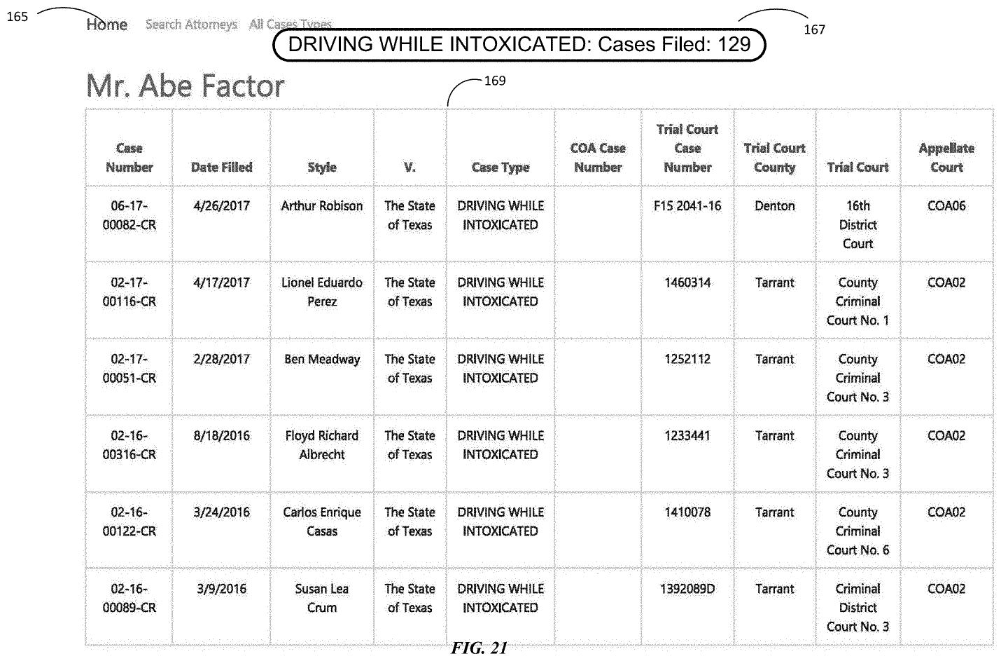

FIG. 20 shows that a user can click on hyperlink 159 which shows the number of Cases 129 filed by the said attorney “Mr. Abe Factor” for the Case Type “DRIVING WHILE INTOXICATED” referenced by 163. When the user clicks on the hyperlink 159 associated with the number of Cases 129, the Program opens up a new webpage as shown in FIG. 21.

FIG. 21 shows the number of Cases filed by the said attorney “Mr. Abe Factor” 165 for the Case Type “DRIVING WHILE INTOXICATED” 167. As it can be seen that the ONLY Cases shown in the Column Case Type, 169, are the Cases specifically filed for “DRIVING WHILE INTOXICATED”.

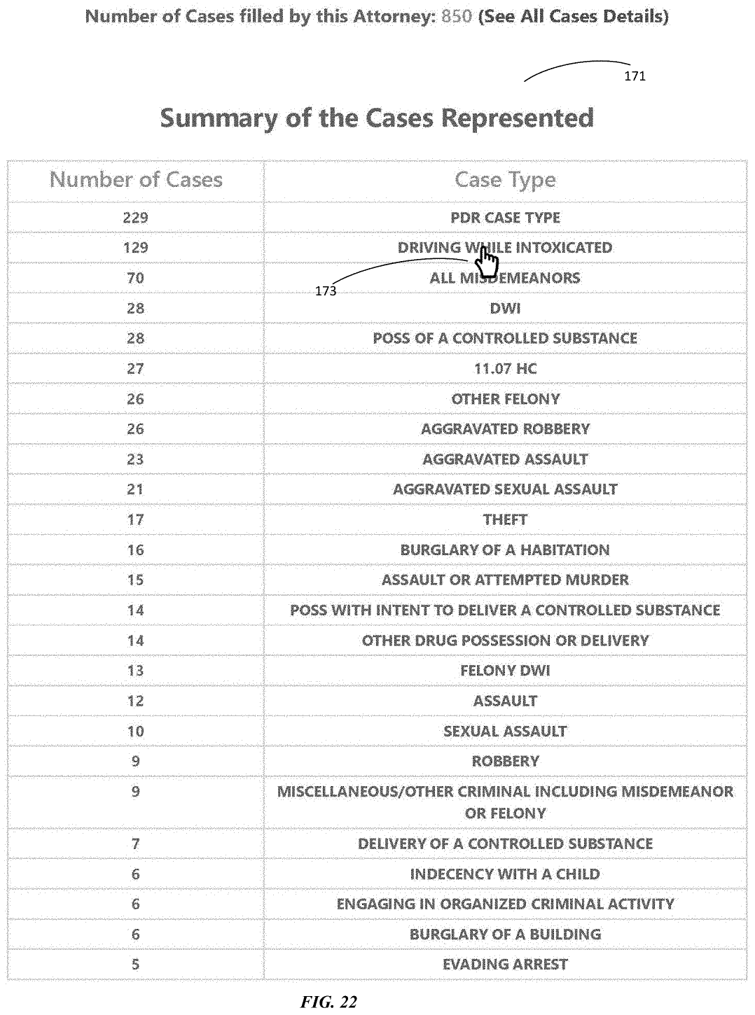

FIG. 22 again shows the “Summary of the Cases Represented” 171. Here the User can chose to click on the hyperlink associated with the Case type of DRIVING WHILE INTOXICATED 173. Once the user clicks on the Case Type 173, the Program opens up a new Webpage as shown on FIG. 23.

FIG. 23 shows the field 175 indicating the “Selected Case Type” of DRIVING WHILE INTOXICATED 176. The Column 177, “Attorney Name” shows by default the most number of Cases filed for the Selected Case Type 175. For example, in this Case the “Selected Case Type” 175 is chosen to be “DRIVING WHILE INTOXICATED 176”. The first entry under the Column 177 shows the name of the attorney Mr. Abe Factor” 180. The reason the said attorney name is shown as the first entry in Column 177 is that the said attorney has filed the most number of Cases specifically for the Case Type DRIVING WHILE INTOXICATED 176.

As shown the said number of Cases in this particular Case Type are 129 referenced by 182. The next Column 187 shows the Total Number of Cases filed by the Attorneys with their listed names in Colum 177. For example, in this Case as mentioned through the previous FIG (FIG. 21), the said attorney Mr. Abe Factor” referenced by 180 has filed the Total Number of Cases to be 850 as referenced by 189. The User can scroll through the webpage and find out about the names of the attorneys through Column 177 along with their number of filed Cases specifically in the Case Type of DRIVING WHILE INTOXICATED 176.

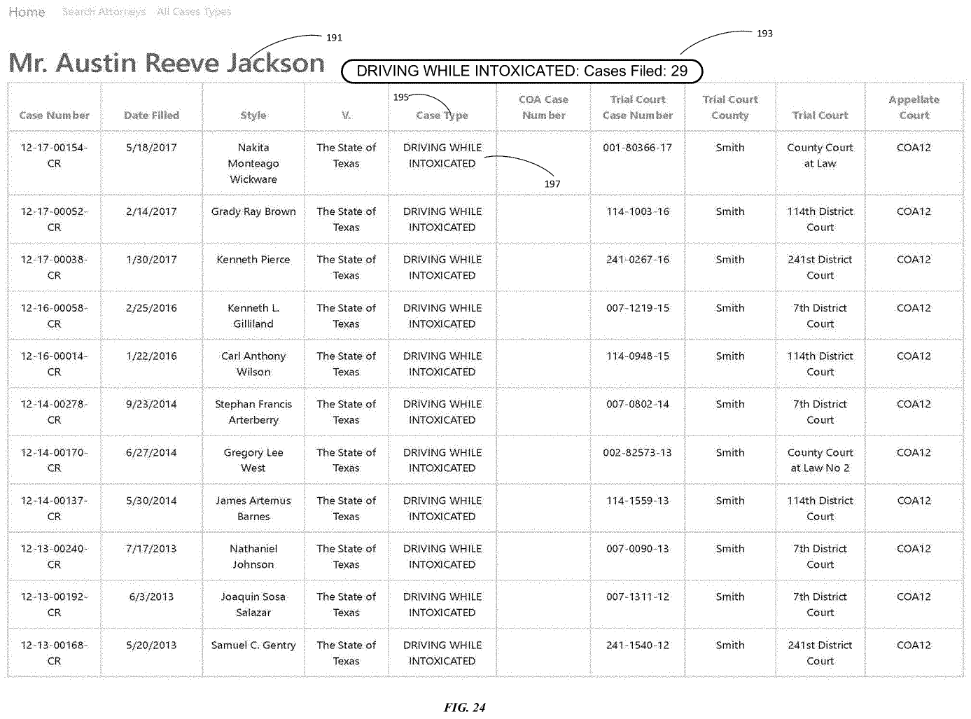

As an example, User wants to get more information about the number of Cases filed by the attorney “Mr. Austin Reeve Jackson” 183 who have filed 29 Cases referenced by 179 specifically for Case Type of DRIVING WHILE INTOXICATED 176. When the User clicks on the hyperlink embedded in the Number of Cases 29, the Program opens up a new webpage as shown in FIG. 24. In addition, the user can click on the number 850 referenced by 189 which has the hyperlink to display all of the Cases filed by the Attorney, Mr. Abe Factor, 180. Similarly, the number 562 referenced by 181 represents all of the Case numbers filed by the Attorney, Mr. Austin Reeve Jackson, 183

FIG. 24 shows the name of the attorney “Mr. Austin Reeve Jackson” 191. The window display 193 shows the number of Cases for Case Type of DRIVING WHILE INTOXICATED 176 filed by the said attorney to be 29. As shown in FIG. 24 that the only Case Type chosen by the user, in this Case, the Case Type of DRIVING WHILE INTOXICATED 197 are displayed in the Column 195. The user can use the sort functionality associated with each Column to display any type of information in the individual column either in the ascending or the descending order.

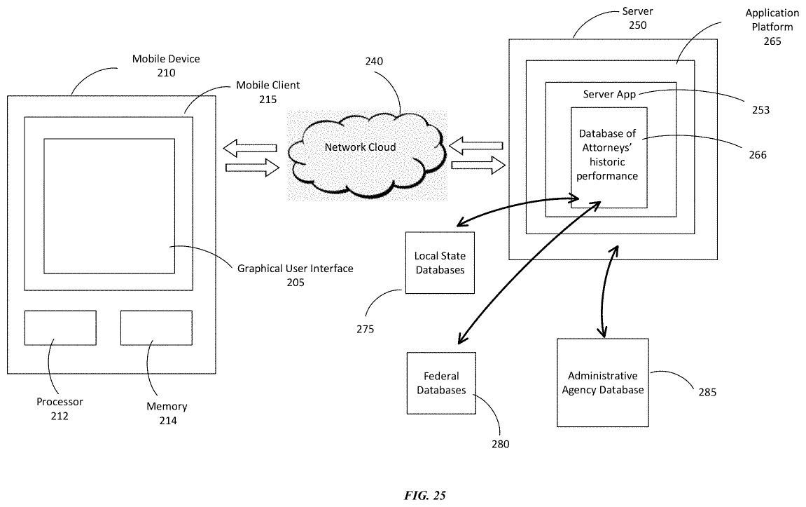

FIG. 25 is an exemplary embodiment of an attorney ranking app system diagram in accordance with an embodiment. The app system may be configured as a software-as-a-service. The a graphic user interface (GUI) 205 is configured on a mobile device (or any computer internet accessible device with an input and display and processing capacity) for access by a set of subscribers or users via a software app, usually via a mobile device 210. The GUI 205 may include a set of inputs for a user to make selections for choosing an attorney, a legal matter, a location, and may also link various interests and other attributes. In an exemplary embodiment, a natural language processing may be performed to search a complex user input with terms that correlate to search terms of the various connected databases. The user input can be considered manner of extracting and identifying data related to finding historic and for verifying information about a particular attorney.

With a continued reference to FIG. 25, a cloud based network system or platform may be used where the mobile device 210 and GUI 205 are communicating via a network cloud 240 to a server 250 for supporting an app which operates on-demand by communicating via the network cloud 240 to the mobile device 210 and which is hosted on a hosted app platform on a server 250. The network cloud 240 can include interconnected networks including both wired and wireless networks for enabling communications of the mobile device 210 via a mobile client 215 to the server app hosted by server 250.

The mobile device 210 may include any mobile or connected computing device configured with a processor 212 and memory 214 programmable by a set of instructions and including “wearable mobile devices” having an operating system capable of running mobile apps individually or in conjunction with other mobile or connected devices. Examples of “wearable mobile devices” include GOOGLE® GLASS™ and ANDROID® watches. The mobile client may be configurable for a multitude of mobile operating systems including ANDROID®, APPLE® iOS, GOGGLE® ANDROID®, and MICROSOFT®'s WINDOWS Phone OS.

The server 250 acts as a host and includes the server app 253 that is configured for access by an application platform 265. The application platform 265 can be configured as a platform as a service (“PaaS) may be part of an architecture where multiple concurrent users utilize the same applications installed on the application platform 265 and is interconnected to a primary historic database of attorney data 266 and other multiple databases (i.e. state databases 275, Federal databases 280, and administrative agency databases 285).

In an exemplary embodiment, the user may be asked a series of questions to answer via a survey or other instruments to determine the best fit attorney. In the instance of asking user questions, the questions may be in the form of hypotheticals, analogies, or real world examples, and may be asked directly or indirectly with respect to the attorney ranking operations in order to extract data from the state databases 275, Federal databases 280, and administrative agency databases 285. As such, the questions associated with the historic data collected about attorneys include a significant number of possibilities but are reduced based on history and prior feedback. In addition, machine learning and artificial intelligence applications may be employed to search remote databases, identify patterns and model data sets in attempts to augment data derived from the sets of questions and input activities.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software, firmware, or the like, various elements of the systems and devices described herein are essentially the code segments or instructions that cause one or more processor devices to perform the various tasks. In certain embodiments, the program or code segments are stored in a tangible processor-readable medium, which may include any medium that can store or transfer information. Examples of a non-transitory and processor-readable medium include an electronic circuit, a semiconductor memory device, a ROM, a flash memory, an erasable ROM (EROM), a floppy diskette, a CD-ROM, an optical disk, a hard disk, or the like.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method for assessing attorney performance based on qualitative data using a software product, the method comprising:
collecting data about cases from at least a local, State and Federal level from databases associated with each level;
collating the data into a framework comprising at least a number of cases and a type of case corresponding to one or more attorneys;
ranking one or more attorneys in accordance with at least the number of cases and the type of case wherein the type of case comprises: civil, administrative and criminal cases;
displaying a list of the each type of case with the number of cases for a particular attorney in an order to rank the particular attorney by the type of case and the number of cases; and
enabling an user upon a selection of one or more cases for a particular attorney to discover a resolution of the case whereby the user can assess the particular attorney based on a type of case, a case number and a resolution.

2. The method of claim 1, further comprising:
displaying detailed information about the case at an appellate level.

3. The method of claim 2, further comprising:
linking appellate briefs about the cases for access by the user.

4. The method of claim 3, further comprising:
generating result data about the case upon a result selection by the user wherein the result data at least comprises a result of: dismissed and affirmed about the case.

5. The method of claim 1, wherein the software product comprises a software-as-a-service (SaaS) application.

6. The method of claim 1, further comprising:
configuring a schema for each case of linking a set of attributes for connecting the databases, the attributes at least comprising: case name, case category, case updates, and parent/child couplings.

7. The method of claim 1, further comprising:
enabling user selection by attorney name or case type and sorting the attorneys by attorney name and case type upon user selections.

8. A computer program product tangibly embodied in a computer-readable storage device and comprising instructions configurable to be executed by a processor to perform a method for ranking attorney in a locality, the method comprising:
collecting data about cases from at least a local, State and Federal level from databases associated with each level;
collating the data into a framework comprising at least a number of cases and a type of case corresponding to one or more attorneys;
ranking one or more attorneys in accordance with at least the number of cases and the type of case wherein the type of case comprises: civil, administrative and criminal cases;
displaying a list of the each type of case with the number of cases for a particular attorney in an order to rank the particular attorney by the type of case and the number of cases; and
enabling an user upon a selection of one or more cases for a particular attorney to discover a resolution of the case whereby the user can assess the particular attorney based on a type of case, a case number and a resolution.

9. The method of claim 8, further comprising:
displaying detailed information about the case at an appellate level.

10. The method of claim 9, further comprising:
linking appellate briefs about the cases for access by the user.

11. The method of claim 10, further comprising:
generating result data about the case upon a result selection by the user wherein the result data at least comprises a result of: dismissed and affirmed about the case.

12. The method of claim 8, wherein the software product comprises a software-as-a-service (SaaS) application.

13. The method of claim 8, further comprising:
configuring a schema for each case of linking a set of attributes for connecting the databases, the attributes at least comprising: case name, case category, case updates, and parent/child couplings.

14. The method of claim 8, further comprising:
enabling user selection by attorney name or case type and sorting the attorneys by attorney name and case type upon user selections.

15. A system comprising:
at least one processor; and
at least one computer-readable storage device comprising instructions configurable to be executed by the at least one processor to perform a method for configuring a display of qualitative data for assessing an attorney by use of a software product, the method comprising:
collecting data about cases from at least a local, State and Federal level from databases associated with each level;
collating the data into a framework comprising at least a number of cases and a type of case corresponding to one or more attorneys;
ranking one or more attorneys in accordance with at least the number of cases and the type of case wherein the type of case comprises: civil, administrative and criminal cases;
displaying a list of the each type of case with the number of cases for a particular attorney in an order to rank the particular attorney by the type of case and the number of cases; and
enabling an user upon a selection of one or more cases for a particular attorney to discover a resolution of the case whereby the user can assess the particular attorney based on a type of case, a case number and a resolution.

16. The method of claim 15, further comprising:
displaying detailed information about the case at an appellate level.

17. The method of claim 16, further comprising:
linking appellate briefs about the cases for access by the user.

18. The method of claim 15, further comprising:
generating result data about the case upon a result selection by the user wherein the result data at least comprises a result of: dismissed and affirmed about the case.

19. The method of claim 15, further comprising:
configuring a schema for each case of linking a set of attributes for connecting the databases, the attributes at least comprising: case name, case category, case updates, and parent/child couplings.

20. The method of claim 15, further comprising:
enabling user selection by attorney name or case type and sorting the attorneys by attorney name and case type upon user selections.
